(19) United States
(12) Patent Application Publication
(10) Pub. No.: US 2026/0290359 A1
(43) Pub. Date: Sep. 24, 2026

(54) AUDIO DATA CODING METHOD AND APPARATUS, AND AUDIO DATA DECODING METHOD AND APPARATUS

(71) Applicant: Douyin Vision Co., Ltd., Beijing (CN)

(72) Inventors: Ziqian WU, Beijing (CN); Dejun ZHANG, Beijing (CN); Jiawei JIANG, Beijing (CN); He WANG, Beijing (CN); Kunpeng LIN, Beijing (CN); Yijian XIAO, Beijing (CN); Piao DING, Beijing (CN); Shenyi SONG, Beijing (CN)

(21) Appl. No.: 18/873,666

(22) PCT Filed: Nov. 3, 2023
(86) PCT No.: PCT/CN2023/129685

§ 371 Date: Dec. 10, 2024

(30) Foreign Application Priority Data
Nov. 7, 2022 (CN) 202211387602.8

(51) Int. Cl. G10L 19/02; G10L 19/22

(52) U.S. Cl. CPC G10L 19/02; G10L 19/22

(57) ABSTRACT

An audio data processing method and apparatus, which relate to the technical field of data processing. The method comprises: determining a coding mode of a first audio frame; determining whether the coding mode of the first audio frame is the same as a coding mode of a second audio frame; if not and the coding mode of the first audio frame is multi-description coding, generating third data according to first data, second data and a first delay; if the coding mode of the first audio frame is not the same as the coding mode of the second audio frame and the coding mode of the first audio frame is single-description coding, generating sixth data according to fourth data, fifth data and a second delay; and coding target data according to the coding mode of the first audio frame to acquire coded data of the first audio frame.

### CROSS-REFERENCE TO RELATED APPLICATIONS

The present application is a national phase application of PCT/CN2023/129685 filed Nov. 3, 2023, which claims priority to and is based on a Chinese application with an application No. 202211387602.8 and a filing date of Nov. 7, 2022, the aforementioned applications are hereby incorporated by reference in their entireties.

### FIELD OF THE INVENTION

The invention relates to the technical field of data processing, in particular to audio data encoding method and apparatus, and audio data decoding method and apparatus.

### BACKGROUND

In VOIP (Voice over Internet Protocol) call, in order to improve audio signal quality, an encoder will adjust a coding mode according to real-time network conditions, such as switching between Multiple Description Coding (MDC) mode and Single Description Coding (SDC) mode.

### DISCLOSURE OF THE INVENTION

In a first aspect, an embodiment of the present disclosure provides an audio data encoding method, including:
determining a coding mode of a first audio frame;
judging whether the coding mode of the first audio frame is the same as a coding mode of a second audio frame; wherein the second audio frame is a previous audio frame of the first audio frame;

If the coding mode of the first audio frame is different from a coding mode of a second audio frame, and the coding mode of the first audio frame is multiple description coding, generating third data based on first data, second data and a first delay; the first data is low-frequency data obtained by frequency division of original audio data of the first audio frame, the second data is low-frequency data obtained by frequency division of original audio data of the second audio frame, and the first delay is a coding delay of the multiple description coding;
performing multiple description coding on the third data to obtain encoded data of the first audio frame.

As an optional implementation of the embodiment of the present disclosure, the method further includes:
if the coding mode of the first audio frame is different from that of the second audio frame, and the coding mode of the first audio frame is single description coding, generating sixth data based on fourth data, fifth data and a second delay; the fourth data is the original audio data of the first audio frame, the fifth data is the original audio data of the second audio frame, and the second delay is a coding delay of the single description coding;
performing single description coding on the sixth data to obtain encoded data of the first audio frame.

As an optional implementation of the embodiment of the present disclosure, the generating the third data based on the first data, the second data and the first delay, includes:
intercepting samples with length of the first delay from the tail end of the second data to obtain seventh data;
splicing the seventh data at the head end of the first data to obtain eighth data;
deleting samples with the length of the first delay from the tail end of the eighth data to obtain the third data.

As an optional implementation of the embodiment of the present disclosure, the generating the sixth data based on the fourth data, the fifth data and the second delay, includes:
intercepting samples with length of the second delay from the tail end of the fifth data to obtain ninth data;
splicing the ninth data at the head end of the fourth data to obtain tenth data;
deleting samples with the length of the second delay from the tail end of the tenth data to obtain the sixth data.

As an optional implementation of the embodiment of the present application, the determining the coding mode of the first audio frame includes:
determining whether a coding mode switching condition is met based on a signal type of the first audio frame and a coding mode duration; wherein the coding mode duration is a playback duration of an audio frame continuously encoded in a current coding mode;
If not, determining the coding mode of the second audio frame as the coding mode of the first audio frame;
If so, determining the coding mode of the first audio frame according to network parameters of an encoded audio data transmission network.

As an optional implementation of the embodiment of the present disclosure, the determining whether the coding mode switching condition is met based on the signal type of the first audio frame and the coding mode duration, includes:
judging whether the coding mode duration is greater than a threshold duration;
judging whether a probability that the first audio frame is a voice audio frame is less than a threshold probability;
If the coding mode duration is greater than the threshold duration and the probability that the first audio frame is a voice audio frame is less than the threshold probability, determining that the coding mode switching condition is met;
if the coding mode duration is less than or equal to the threshold duration and/or the probability that the first audio frame is a voice audio frame is greater than or equal to the threshold probability, determining that the coding mode switching condition is not met.

As an optional implementation of the embodiment of the present disclosure, the determining the coding mode of the first audio frame according to network parameters of the encoded audio data transmission network, includes:
determining a packet loss rate of the encoded audio data transmission network according to the network parameters;
judging whether the packet loss rate is greater than or equal to a threshold packet loss rate;
If so, determining that the coding mode of the first audio frame is the multiple description coding;
If not, determining that the coding mode of the first audio frame is the single description coding.

In a second aspect, an embodiment of the present disclosure provides an audio data decoding method, including:
determining a coding mode of a first audio frame according to encoded data of the first audio frame;
decoding the encoded data of the first audio frame according to the coding mode to obtain decoded data;
judging whether the coding mode of the first audio frame is the same as a coding mode of a second audio frame; the second audio frame is a previous audio frame of the first audio frame;
If not, and the coding mode of the first audio frame is multiple description coding, generating packet loss concealment data based on the second audio frame;
smoothing the decoded data according to delay data of the second audio frame and the packet loss concealment data to obtain playback data of the first audio frame.

As an optional implementation of the embodiment of the present disclosure, the method further comprises:
if the coding mode of the first audio frame is different from the coding mode of the second audio frame, and the coding mode of the first audio frame is single description coding, generating the packet loss concealment data based on the second audio frame;
smoothing the decoded data according to the packet loss concealment data, to obtain a smoothing result corresponding to the decoded data;
delaying the smoothing result according to the packet loss concealment data and a delayed sample number to obtain the playback data of the first audio frame; the delayed sample number is the delayed sample number in the multiple description coding.

As an optional implementation of the embodiment of the present disclosure, the smoothing the decoded data according to the packet loss concealment data to obtain the smoothing result corresponding to the decoded data, includes:
replacing a first sample sequence in the decoded data with a second sample sequence in the packet loss concealment data to obtain a first replacement result; the first sample sequence is a sample sequence composed of top first number of samples in the decoded data, and the first number is a difference between a first preset number and the delayed sample number; the second sample sequence is a sample sequence composed of samples in the packet loss concealment data whose index values range from the delayed sample number to the first preset number;
windowing and superimposing a third sample sequence in the first replacement result and a fourth sample sequence in the packet loss concealment data based on a first window function to obtain a smoothing result corresponding to the decoded data, wherein the third sample sequence is a sample sequence composed of samples in the first replacement result whose index values range from the first number to a sum of the first number and a second preset number; the fourth sample sequence is a sample sequence composed of samples in the packet loss concealment data whose index values range from the first preset number to a sum of the first preset number and a second preset number.

As an optional implementation of the embodiment of the present disclosure, the delaying the smoothing result according to the packet loss concealment data and the delayed sample number to obtain the playback data of the first audio frame, includes:
acquiring a fifth sample sequence, wherein the fifth sample sequence is a sample sequence composed of top delayed sample number of samples in the packet loss concealment data;
splicing the fifth sample sequence in front of the smoothing result to obtain a first splicing result;
deleting a sixth sample sequence in the first splicing result to obtain the playback data of the first audio frame, wherein the sixth sample sequence is a sample sequence composed of bottom delayed sample number of samples in the first splicing result.

As an optional implementation of the embodiment of the present disclosure, the smoothing the decoded data according to delay data of the second audio frame and the packet loss concealment data to obtain the playback data of the first audio frame, includes:
replacing a seventh sample sequence in the decoded data with the delayed data to obtain a second replacement result; the seventh sample sequence is a sample sequence composed of top delayed sample number of samples in the decoded data;
windowing and superimposing an eighth sample sequence in the second replacement result and a ninth sample sequence in the packet loss concealment data based on a second window function to obtain the playback data of the first audio frame, wherein the eighth sample sequence is a sample sequence composed of samples in the second replacement result whose index values range from the delayed sample number to a sum of the delayed sample number and a third preset number; the ninth sample sequence is a sample sequence composed of top third preset number of samples in the packet loss concealment data.

As an optional implementation of the embodiment of the present disclosure, the method further comprises:
if the coding mode of the first audio frame is the same as the coding mode of the second audio frame, and the coding mode of the first audio frame is single description coding, delaying the decoded data according to delayed data of the second audio frame and the delayed sample number to obtain the playback data of the first audio frame.

As an optional implementation of the embodiment of the present disclosure, the delaying the decoded data according to delayed data of the second audio frame and the delayed sample number to obtain the playback data of the first audio frame, includes:
splicing the delayed data in front of the decoded data to obtain a second splicing result;
deleting a tenth sample sequence in the second splicing result to obtain the playback data of the first audio frame, wherein the tenth sample sequence is a sample sequence composed of bottom delayed sample number of samples in the second splicing result.

In a third aspect, an embodiment of the present disclosure provides an audio data encoding apparatus, comprising:
a determination unit, configured to determine a coding mode of a first audio frame;
a judgement unit, configured to judge whether the coding mode of the first audio frame is the same as a coding mode of a second audio frame; wherein the second audio frame is a previous audio frame of the first audio frame;
a generation unit, configured to, in response to that the coding mode of the first audio frame is different from a coding mode of a second audio frame and the coding mode of the first audio frame is multiple description coding, generate third data based on first data, second data and a first delay; the first data is low-frequency data obtained by frequency division of original audio data of the first audio frame, the second data is low-frequency data obtained by frequency division of original audio data of the second audio frame, and the first delay is a coding delay of the multiple description coding;
an encoding unit, configured to perform multiple description coding on the third data to obtain encoded data of the first audio frame.

As an optional implementation of the embodiment of the present disclosure, wherein the generation unit is further configured to, in response to that the coding mode of the first audio frame is different from that of the second audio frame and the coding mode of the first audio frame is single description coding, generate sixth data based on fourth data, fifth data and a second delay; the fourth data is the original audio data of the first audio frame, the fifth data is the original audio data of the second audio frame, and the second delay is a coding delay of the single description coding;
the encoding unit is further configured to perform single description coding on the sixth data to obtain encoded data of the first audio frame.

As an optional implementation of the embodiment of the present disclosure, the generation unit is specifically configured to: intercept samples with length of the first delay from the tail end of the second data to obtain seventh data; splice the seventh data at the head end of the first data to obtain eighth data; delete samples with the length of the first delay from the tail end of the eighth data to obtain the third data.

As an optional implementation of the embodiment of the present disclosure, the generation unit is specifically configured to: intercept samples with length of the second delay from the tail end of the fifth data to obtain ninth data; splice the ninth data at the head end of the fourth data to obtain tenth data; delete samples with the length of the second delay from the tail end of the tenth data to obtain the sixth data.

As an optional implementation of the embodiment of the present application, the determination unit is specifically configured to: determine whether a coding mode switching condition is met based on a signal type of the first audio frame and a coding mode duration; wherein the coding mode duration is a playback duration of an audio frame continuously encoded in a current coding mode; if not, determine the coding mode of the second audio frame as the coding mode of the first audio frame; if so, determine the coding mode of the first audio frame according to network parameters of an encoded audio data transmission network.

As an optional implementation of the embodiment of the present disclosure, the determination unit is specifically configured to: judge whether the coding mode duration is greater than a threshold duration; judge whether a probability that the first audio frame is a voice audio frame is less than a threshold probability; in response to that the coding mode duration is greater than the threshold duration and the probability that the first audio frame is a voice audio frame is less than the threshold probability, determine that the coding mode switching condition is met; in response to that the coding mode duration is less than or equal to the threshold duration and/or the probability that the first audio frame is a voice audio frame is greater than or equal to the threshold probability, determine that the coding mode switching condition is not met.

As an optional implementation of the embodiment of the present disclosure, the determination unit is specifically configured to: determine a packet loss rate of the encoded audio data transmission network according to the network parameters; judge whether the packet loss rate is greater than or equal to a threshold packet loss rate; if so, determine that the coding mode of the first audio frame is the multiple description coding; if not, determine that the coding mode of the first audio frame is the single description coding.

In a fourth aspect, an embodiment of the present disclosure provides an audio data decoding apparatus, including:
a determination unit, configured to determine a coding mode of a first audio frame according to encoded data of the first audio frame;
a decoding unit, configured to decode the encoded data of the first audio frame according to the coding mode to obtain decoded data;
a judgement unit, configured to judge whether the coding mode of the first audio frame is the same as a coding mode of a second audio frame; the second audio frame is a previous audio frame of the first audio frame;
a processing unit, configured to, in response to that the coding mode of the first audio frame is different from a coding mode of a second audio frame and the coding mode of the first audio frame is multiple description coding, generate packet loss concealment data based on the second audio frame; and smooth the decoded data according to delay data of the second audio frame and the packet loss concealment data to obtain playback data of the first audio frame.

As an optional implementation of the embodiment of the present disclosure, the processing unit is further configured to: in response to that the coding mode of the first audio frame is different from the coding mode of the second audio frame, and the coding mode of the first audio frame is single description coding, generate the packet loss concealment data based on the second audio frame; smooth the decoded data according to the packet loss concealment data, to obtain a smoothing result corresponding to the decoded data; delay the smoothing result according to the packet loss concealment data and a delayed sample number to obtain the playback data of the first audio frame; the delayed sample number is the delayed sample number in the multiple description coding.

As an optional implementation of the embodiment of the present disclosure, the processing unit is further configured to: replace a first sample sequence in the decoded data with a second sample sequence in the packet loss concealment data to obtain a first replacement result; the first sample sequence is a sample sequence composed of top first number of samples in the decoded data, and the first number is a difference between a first preset number and the delayed sample number; the second sample sequence is a sample sequence composed of samples in the packet loss concealment data whose index values range from the delayed sample number to the first preset number; window and superimpose a third sample sequence in the first replacement result and a fourth sample sequence in the packet loss concealment data based on a first window function to obtain a smoothing result corresponding to the decoded data, wherein the third sample sequence is a sample sequence composed of samples in the first replacement result whose index values range from the first number to a sum of the first number and a second preset number; the fourth sample sequence is a sample sequence composed of samples in the packet loss concealment data whose index values range from the first preset number to a sum of the first preset number and a second preset number.

As an optional implementation of the embodiment of the present disclosure, the processing unit is specifically configured to: acquire a fifth sample sequence, wherein the fifth sample sequence is a sample sequence composed of top delayed sample number of samples in the packet loss concealment data; splice the fifth sample sequence in front of the smoothing result to obtain a first splicing result; delete a sixth sample sequence in the first splicing result to obtain the playback data of the first audio frame, wherein the sixth sample sequence is a sample sequence composed of bottom delayed sample number of samples in the first splicing result.

As an optional implementation of the embodiment of the present disclosure, the processing unit is specifically configured to: replace a seventh sample sequence in the decoded data with the delayed data to obtain a second replacement result; the seventh sample sequence is a sample sequence composed of top delayed sample number of samples in the decoded data; window and superimpose an eighth sample sequence in the second replacement result and a ninth sample sequence in the packet loss concealment data based on a second window function to obtain the playback data of the first audio frame, wherein the eighth sample sequence is a sample sequence composed of samples in the second replacement result whose index values range from the delayed sample number to a sum of the delayed sample number and a third preset number; the ninth sample sequence is a sample sequence composed of top third preset number of samples in the packet loss concealment data.

As an optional implementation of the embodiment of the present disclosure, the processing unit is configured to: in response to that the coding mode of the first audio frame is the same as the coding mode of the second audio frame, and the coding mode of the first audio frame is single description coding, delay the decoded data according to delayed data of the second audio frame and the delayed sample number to obtain the playback data of the first audio frame.

As an optional implementation of the embodiment of the present disclosure, the processing unit is specifically configured to: splice the delayed data in front of the decoded data to obtain a second splicing result; delete a tenth sample sequence in the second splicing result to obtain the playback data of the first audio frame, wherein the tenth sample sequence is a sample sequence composed of bottom delayed sample number of samples in the second splicing result.

In a fifth aspect, an embodiment of the present disclosure provides an electronic device, including a memory and a processor, wherein the memory is used for storing a computer program; when executing the computer program, the processor is used to cause the electronic device to implement the audio data encoding method or the audio data decoding method described in any of the above embodiments.

In a sixth aspect, an embodiment of the present disclosure provides a computer-readable storage medium that, when a computer program is executed by a computing device, causes the computing device to implement the audio data encoding method or the audio data decoding method described in any of the above embodiments.

In a seventh aspect, an embodiment of the present disclosure provides a computer program product, which, when running on a computer, causes the computer to implement the audio data encoding method or the audio data decoding method described in any of the above embodiments.

### DESCRIPTION OF THE DRAWINGS

The accompanying drawings, which are incorporated in and constitute a part of this specification, illustrate embodiments consistent with the present disclosure and, together with the description, serve to explain the principles of the present disclosure.

In order to explain the technical schemes in the embodiments of the present disclosure or the prior art more clearly, the drawings that need to be called in the description of the embodiments or the prior art will be briefly introduced below. Obviously, for those ordinary skilled in the art, other drawings can be obtained according to these drawings without paying creative labor.

FIG. 1 is a first one of flow charts of steps of an audio data encoding method provided by an embodiment of the present disclosure;

FIG. 2 is a first one of schematic diagrams of an audio data encoding method provided by an embodiment of the present disclosure;

FIG. 3 is a second one of schematic diagrams of an audio data encoding method provided by an embodiment of the present disclosure;

FIG. 4 is a second one of flow charts of steps of an audio data encoding method provided by an embodiment of the present disclosure;

FIG. 5 is a third one of flow charts of steps of an audio data encoding method provided by an embodiment of the present disclosure;

FIG. 6 is a first one of flow charts of steps of an audio data decoding method provided by an embodiment of the present disclosure;

FIG. 7 is a second one of flow charts of steps of an audio data decoding method provided by an embodiment of the present disclosure;

FIG. 8 is a first one of schematic diagrams of an audio data decoding method provided by an embodiment of the present disclosure;

FIG. 9 is a second one of schematic diagrams of an audio data decoding method provided by an embodiment of the present disclosure;

FIG. 10 is a third one of schematic diagrams of an audio data decoding method provided by an embodiment of the present disclosure;

FIG. 11 is a fourth one of schematic diagrams of an audio data decoding method provided by an embodiment of the present disclosure;

FIG. 12 is a fifth one of schematic diagrams of an audio data decoding method provided by an embodiment of the present disclosure;

FIG. 13 is a third one of flow charts of steps of an audio data decoding method provided by an embodiment of the present disclosure;

FIG. 14 is a sixth one of schematic diagrams of an audio data decoding method provided by an embodiment of the present disclosure;

FIG. 15 is a schematic structural diagram of an audio data encoding apparatus provided by an embodiment of the present disclosure;

FIG. 16 is a schematic structural diagram of an audio data decoding apparatus provided by an embodiment of the present disclosure;

FIG. 17 is a schematic diagram of the hardware structure of an electronic device provided by an embodiment of the present disclosure.

### DETAILED DESCRIPTION OF PREFERRED EMBODIMENTS

In order to understand the above objects, features and advantages of the present disclosure more clearly, the schemes of the present disclosure will be further described below. It should be noted that the embodiments of the present disclosure and the features in the embodiments can be combined with each other without conflict.

In the following description, many specific details are set forth in order to fully understand the present disclosure, but the present disclosure may be practiced in other ways than those described herein; Obviously, the embodiments in the specification are only part of the embodiments of the present disclosure, not all of them.

In embodiments of the present disclosure, the words “exemplary” or “for example” are used to express examples, illustrations or explanations. Any embodiment or design described as “exemplary” or “for example” among the embodiments of the present disclosure should not be interpreted as being more preferred or advantageous than other embodiments or designs. To be exact, the words “exemplary” or “for example” are called to present related concepts in a concrete way. In addition, in the description of embodiments of the present disclosure, unless otherwise specified, the meaning of “a plurality of” refers to two or more.

Because the multiple description coding MDC mode and the single description coding SDC mode use different coding algorithms, parameters such as delay, sampling rate, etc. may be inconsistent, which leads to a problem of audio discontinuity and/or noise appearance when the audio data is decoded in the case of switching coding modes.

In view of this, embodiments of the present disclosure provide an encoding method, a decoding method, and apparatuses for audio data, which can be used for improving audio signal quality in the case of switching coding modes.

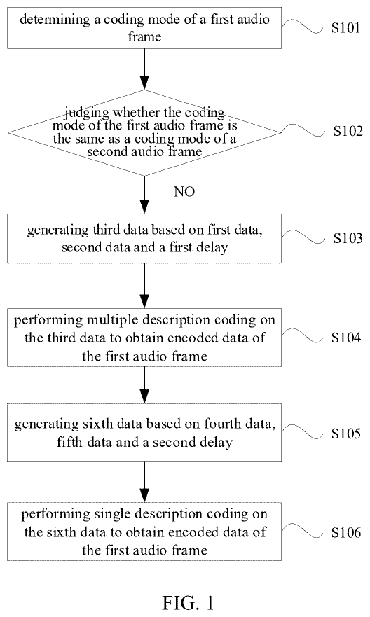

An embodiment of the present disclosure provides an audio data encoding method. Referring to FIG. 1, the audio data encoding method includes the following steps:
S101. determining a coding mode of a first audio frame.

In an embodiment of the present disclosure, the coding modes of audio frames may include Single Description Coding (SDC) and Multiple Description Coding (MDC).
S102. judging whether the coding mode of the first audio frame is the same as a coding mode of a second audio frame.

Where, the second audio frame is a previous audio frame of the first audio frame;

In the above step S102, if the coding mode of the first audio frame is different from the coding mode of a second audio frame, and the coding mode of the first audio frame is multiple description coding, the following steps S103 and S104 will be executed:
S103. generating third data based on first data, second data and a first delay.

Where, the first data is low-frequency data obtained by frequency division of original audio data of the first audio frame, the second data is low-frequency data obtained by frequency division of original audio data of the second audio frame, and the first delay is a coding delay of the multiple description coding.

In some embodiments, if the coding mode of a current audio frame is multi description coding, the original data of the current audio frame is written into a delay buffer (delay_buffer), while if the coding mode of the current audio frame is single description coding, the low-frequency data obtained by frequency division of the original data of the current audio frame is written into a designated buffer, so that when the second data needs to be obtained, the low-frequency data obtained by frequency division of the original audio data of the previous audio frame can be directly read from the delay_buffer.
S104. performing multiple description coding on the third data to obtain encoded data of the first audio frame.

In the above step S102, if the coding mode of the first audio frame is different from the coding mode of the second audio frame, and the coding mode of the first audio frame is single description coding, the following steps S105 and S106 will be executed:
S105, generating sixth data based on fourth data, fifth data and a second delay.

Where, the fourth data is the original audio data of the first audio frame, the fifth data is the original audio data of the second audio frame. The second delay is a coding delay of the single description coding.
S106: performing single description coding on the sixth data to obtain encoded data of the first audio frame.

The encoding method and decoding method for audio data provided by embodiments of the present disclosure generate target data through the following steps: determining a coding mode of a first audio frame; judging whether the coding mode of the first audio frame is the same as a coding mode of a second audio frame; if the coding mode of the first audio frame is different from a coding mode of a second audio frame, and the coding mode of the first audio frame is multiple description coding, generating the target data based on first data, second data and a first delay. Because, when the coding mode of the first audio frame is different from a coding mode of a second audio frame, and the coding mode of the first audio frame is multiple description coding, the encoding method of audio data provided by the embodiments of the present disclosure can process the low-frequency data obtained by frequency division of the original audio data of the first audio frame according to the low-frequency data obtained by frequency division of the original audio data of the second audio frame and the coding delay of the multiple description coding, and then encode the third data obtained by processing, the embodiments of the present disclosure can avoid the problem of audio discontinuity and/or noise appearance when coding mode is switched from the single description coding to the multiple description coding, and thereby improve the audio signal quality.

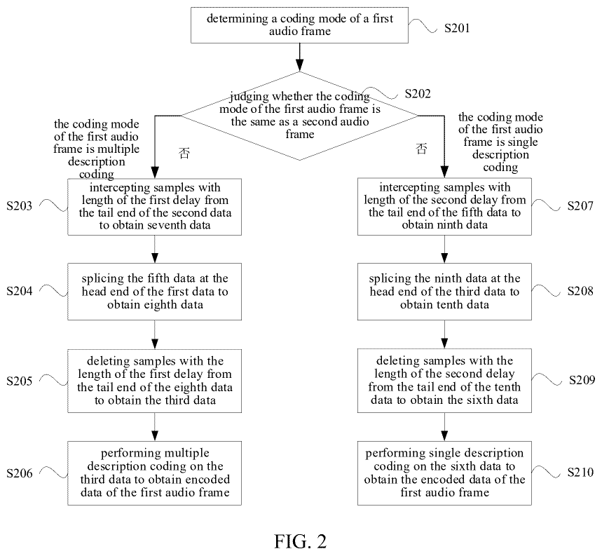

As refinement and extension of the above embodiments, an embodiment of the present disclosure provides an audio data encoding method. Referring to FIG. 2, the audio data encoding method includes the following steps:
S201. determining a coding mode of a first audio frame.

That is, the coding mode of the current audio frame is determined.
S202. judging whether the coding mode of the first audio frame is the same as a coding mode of a second audio frame.

Where, the second audio frame is a previous audio frame of the first audio frame.

That is, it is judged whether the coding mode of the current audio frame is the same as the coding mode of the previous audio frame.

In the above step S202, if the coding mode of the first audio frame is different from the coding mode of a second audio frame, and the coding mode of the first audio frame is multiple description coding, the following steps S203 and S206 will be executed:
S203. intercepting samples with length of the first delay from the tail end of the second data to obtain seventh data;
S204. splicing the seventh data at the head end of the first data to obtain eighth data;
S205. deleting samples with the length of the first delay from the tail end of the eighth data to obtain the third data.
S206: performing multiple description coding on the third data to obtain encoded data of the first audio frame.

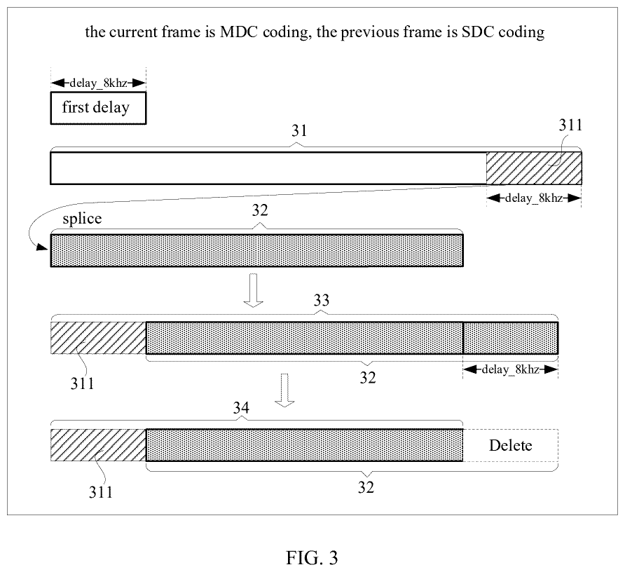

When the coding mode of the first audio frame is different from the coding mode of a second audio frame, and the coding mode of the first audio frame is multiple description coding, that is, when the coding mode of the current audio frame is multiple description coding and the coding mode of the previous audio frame is single description coding, as shown in FIG. 3, the first delay length in FIG. 3 is delay_8 kHZ. The data cached in the delay_buffer is low-frequency data (second data 31) obtained by frequency division of the original data of the second audio frame, and the input to the encoder in the multiple description coding is low-frequency data (first data 32) obtained by frequency division of the first audio frame. The data processing process of the above steps S203 to S205 includes: firstly, intercepting samples with the length of the delay_8 kHZ from the tail end of the second data 31 to obtain the seventh data 311; secondly, splicing the seventh data 311 at the head end of the first data 32 to obtain the eighth data 33; and finally, deleting samples with the length of the delay_8 kHZ from the tail end of the eighth data 33 to obtain the third data 34. As shown in FIG. 3, the third data 34 is composed of two parts, one part is the seventh data 311, and the other part is the remaining data of the first data 32 after deleting the samples with the length of the delay_8 kHZ from the tail end of the first data 32.

In the above step S202, if the coding mode of the first audio frame is different from the coding mode of a second audio frame, and the coding mode of the first audio frame is single description coding, the following steps S207 and S210 will be executed:
S207. intercepting samples with length of the second delay from the tail end of the fifth data to obtain ninth data;
S208. splicing the ninth data at the head end of the third data to obtain tenth data;
S209. deleting samples with the length of the second delay from the tail end of the tenth data to obtain the sixth data.
S210: performing single description coding on the sixth data to obtain the encoded data of the first audio frame.

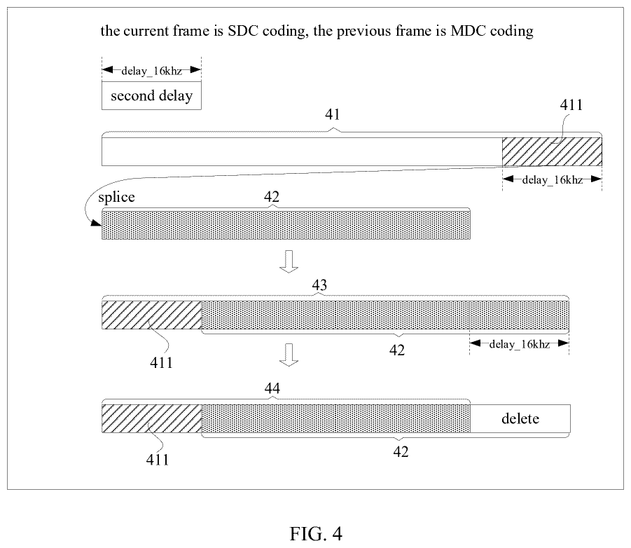

When the coding mode of the first audio frame is different from the coding mode of a second audio frame, and the coding mode of the first audio frame is single description coding, that is, when the coding mode of the current audio frame is single description coding and the coding mode of the previous audio frame is multiple description coding, as shown in FIG. 4, the second delay length in FIG. 4 is delay_16 kHZ. The data cached in the delay_buffer is original audio data (fifth data 41) of the second audio frame, and the input to the encoder in the single description coding is original audio data (fourth data 42) of the first audio frame. The data processing process of the above steps S207 to S209 includes: firstly, intercepting samples with the length of the delay_16 kHZ from the tail end of the fifth data 41 to obtain the ninth data 411; secondly, splicing the ninth data 411 at the head end of the fourth data 42 to obtain the tenth data 43; and finally, deleting samples with the length of the delay_16 kHZ from the tail end of the tenth data 43 to obtain the sixth data 44. As shown in FIG. 4, the sixth data 44 is composed of two parts, one part is the ninth data 411, and the other part is the remaining data of the fourth data 42 after deleting the samples with the length of the delay_16 kHZ from the tail end of the fourth data 42.

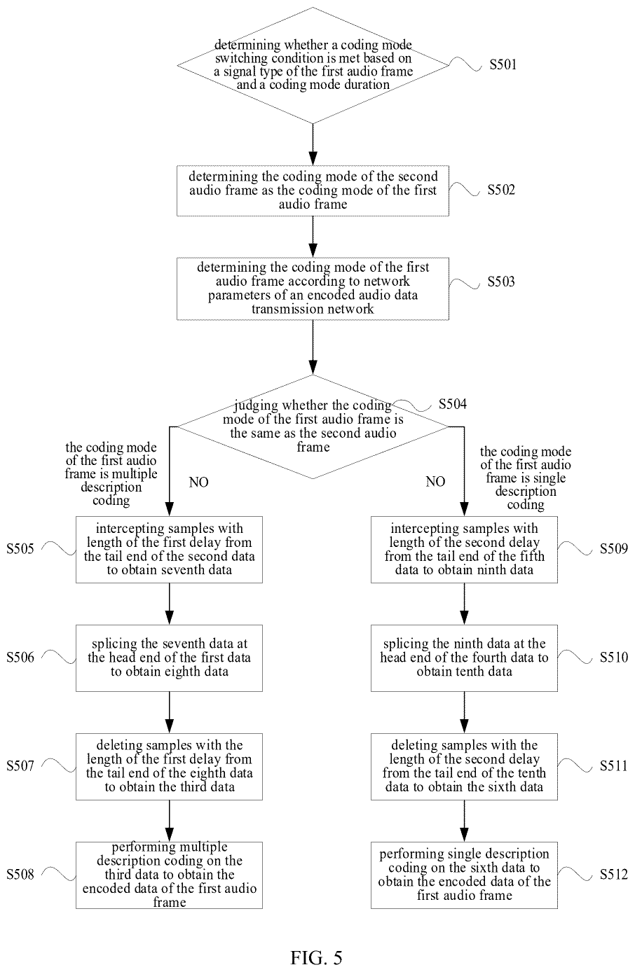

As refinement and extension of the above embodiments, an embodiment of the present disclosure provides a method for processing audio data. Referring to FIG. 5, the method for processing audio data includes:
S501: determining whether a coding mode switching condition is met based on a signal type of the first audio frame and a coding mode duration.

Where the coding mode duration is a playback duration of an audio frame continuously encoded in a current coding mode.

In some embodiments, the implementation of determining whether a coding mode switching condition is met based on a signal type of the first audio frame and a coding mode duration may include the following steps a to d:

Step a, judging whether the coding mode duration is greater than a threshold duration.

The embodiments of the present application do not limit the threshold duration, and for example, the threshold duration may be 2 s.

In the above step a, if the coding mode duration is less than or equal to the threshold duration, then the following step b is executed.

Step b, determining that the coding mode switching condition is not met.

In the above step a, if the coding mode duration is greater than the threshold duration, then the following steps c to e are executed:

Step c, judging whether a probability that the first audio frame is a voice audio frame is less than a threshold probability.

In the above step c, if the probability that the first audio frame is a voice audio frame is less than the threshold probability, then the following step d is executed:

Step d, determining that the coding mode switching condition is met.

In the above step c, if the probability that the first audio frame is a voice audio frame is greater than or equal to the threshold probability, then the following step e is executed:
step e, determining that the coding mode switching condition is not met.

That is, if the coding mode duration is less than or equal to the threshold duration and/or the probability that the first audio frame is a voice audio frame is greater than or equal to the threshold probability, then it is determined that the coding mode switching condition is not met.

In the above step S501, if the coding mode switching condition is not met, then the following step S502 is executed:
S502: determining the coding mode of the second audio frame as the coding mode of the first audio frame.

That is, the coding mode of the previous audio frame will continue to use.

In the above step S501, if the coding mode switching condition is met, then the following step S503 is executed:
S503: determining the coding mode of the first audio frame according to network parameters of an encoded audio data transmission network.

In some embodiments, the implementation steps of step S503 (determining the coding mode of the first audio frame according to network parameters of an encoded audio data transmission network) can include the following step 1 to step 3:

Step 1, determining a packet loss rate of the encoded audio data transmission network according to the network parameters.

In embodiments of the present disclosure, the Packet Loss Rate may refer to a ratio of the number of lost data packets to all transmitted data packets in the process of data packet transmission.

Step 2, judging whether the packet loss rate is greater than or equal to a threshold packet loss rate.

The embodiments of the present disclosure do not limit the threshold packet loss rate, for example, the threshold packet loss rate may be 5%.

In the above step 2, if the packet loss rate is greater than or equal to the threshold packet loss rate, then the following step 3 is executed, and if the packet loss rate is less than the threshold packet loss rate, then the following step 4 is executed:

Step 3, determining that the coding mode of the first audio frame is the multiple description coding.

Step 4, determining that the coding mode of the first audio frame is the single description coding.
S504: judging whether the coding mode of the first audio frame is the same as the coding mode of the second audio frame.

In S504, if the coding mode of the first audio frame is different from that of the second audio frame and the coding mode of the first audio frame is multiple description coding, then the following S505 to S508 are executed:
S505: intercepting samples with length of the first delay from the tail end of the second data to obtain seventh data.

Where, the second data is low-frequency data obtained by frequency division of original audio data of the second audio frame, and the first delay is a coding delay of the multiple description coding.
S506: splicing the seventh data at the head end of the first data to obtain eighth data.

Where, the first data is low-frequency data obtained by frequency division of original audio data of the first audio frame.
S507: deleting samples with the length of the first delay from the tail end of the eighth data to obtain the third data.
S508: performing multiple description coding on the third data to obtain the encoded data of the first audio frame.

In the above S504, if the coding mode of the first audio frame is different from that of the second audio frame and the coding mode of the first audio frame is single description coding, then the following S509 to S512 are executed:
S509: intercepting samples with length of the second delay from the tail end of the fifth data to obtain ninth data;
S510: splicing the ninth data at the head end of the fourth data to obtain tenth data;
S511: deleting samples with the length of the second delay from the tail end of the tenth data to obtain the sixth data.
S512: performing single description coding on the sixth data to obtain the encoded data of the first audio frame.

In the above S504, if the coding mode of the first audio frame is the same as that of the second audio frame and the coding mode of the first audio frame is multi-description coding, then performing multiple description coding on low-frequency data obtained by frequency division of the original audio data of the first audio frame to obtain the encoded data of the first audio frame, in the above S504, if the coding mode of the first audio frame is the same as that of the second audio frame and the coding mode of the first audio frame is single description coding, performing single description coding on the original audio data of the first audio frame to obtain the encoded data of the first audio frame.

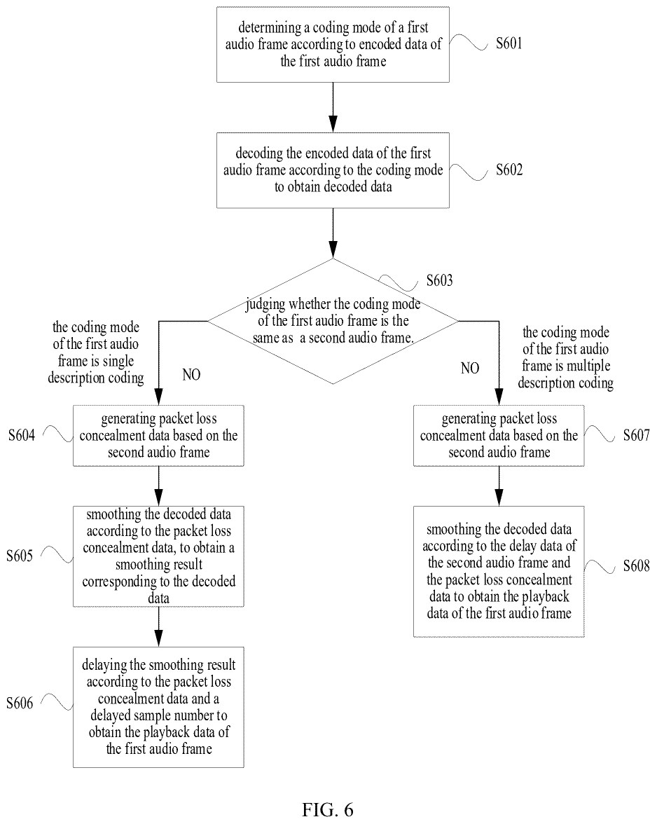

An embodiment of the present disclosure provides an audio data decoding method. Referring to FIG. 6, the audio data decoding method includes:
S601: determining a coding mode of a first audio frame according to encoded data of the first audio frame.
S602: decoding the encoded data of the first audio frame according to the coding mode to obtain decoded data.
S603: judging whether the coding mode of the first audio frame is the same as a coding mode of a second audio frame.

Where, the second audio frame is a previous audio frame of the first audio frame.

In S603, if the coding mode of the first audio frame is different from that of the second audio frame, and the coding mode of the first audio frame is single description coding, then the following S604 to S606 are executed:
S604: generating packet loss concealment data based on the second audio frame.

The packet loss concealment data is data obtained based on Packet Loss Concealment (PLC) mechanism, which can be used by a media engine to solve the problem of network packet loss. When the media engine receives a series of media stream data packets, it cannot be guaranteed that all the packets are received. If a packet is lost, and the Forward Error Correction (FEC) mechanism is not used at this time, the packet loss concealment mechanism will work. The Packet loss concealment mechanism is not standard consistent, which allows to be implemented and expanded by media engines and codecs according to their own conditions.

The packet loss concealment data in the embodiment of the present application may be data with a length of 10 ms.
S605: smoothing the decoded data according to the packet loss concealment data, to obtain a smoothing result corresponding to the decoded data.
S606: delaying the smoothing result according to the packet loss concealment data and a delayed sample number to obtain the playback data of the first audio frame.

Where, the delayed sample number is the delayed sample number in the multiple description coding.

In an embodiment of the present disclosure, since the MDC algorithm itself has a delay of qmf_order−1 samples, when the coding mode of the first audio frame is MDC, the delay of the decoded output audio can be set to 0, while when the coding mode of the first audio frame is SDC, in order to align with the delay of the MDC algorithm, it is necessary to set the delay of the decoded output audio to qmf_order-1, and the aligning the delays of such two algorithms can be achieved by the following formula:

$$\{ \begin{matrix}delayed sample number = qmf\_order - 1 , & coding mode = SDC \\ delayed sample number = 0 , & coding mode = MDC\end{matrix}$$

In the above S603, if the coding mode of the first audio frame is different from that of the second audio frame, and the coding mode of the first audio frame is multiple description coding, then the following S607 and S608 are executed:
S607: generating packet loss concealment data based on the second audio frame.
S608: smoothing the decoded data according to the delay data of the second audio frame and the packet loss concealment data to obtain the playback data of the first audio frame.

In the above embodiments, when the data packets of the first audio data is decoded, firstly, the coding mode of the first audio frame is determined according to the encoded data of the first audio frame, then the encoded data of the first audio frame is decoded according to the coding mode to obtain decoded data, and then it is judged whether the coding mode of the first audio frame is the same as that of the second audio frame, if the coding modes are different and the coding mode of the first audio frame is single description coding, then the packet loss concealment data is generated based on the second audio frame, and the decoded data is smoothed according to the packet loss concealment data to obtain a smoothing result corresponding to the decoded data. The smoothing result is delayed according to the packet loss concealment data and the delayed sample number to obtain the playback data of the first audio frame; if the coding modes are different and the coding mode of the first audio frame is multiple description coding, the packet loss concealment data is generated based on the second audio frame, and then the decoded data is smoothed according to the delay data of the second audio frame and the packet loss concealment data to obtain the playback data of the first audio frame. In the audio data decoding method provided by the embodiments of the present disclosure, when the coding mode of the first audio frame is different from that of the second audio frame and the coding mode of the first audio frame is single description coding, packet loss concealment data can be generated based on the second audio frame, and then the decoded data is smoothed to obtain the playback data of the first audio frame; when the coding mode of the first audio frame is different from that of the second audio frame, and the coding mode of the first audio frame is multiple description coding, packet loss concealment data can be generated based on the second audio frame, and then the playback data of the first audio frame will be obtained in conjunction with the delay data of the second audio frame, therefore, when the coding mode of the first audio frame is different from that of the second audio frame, the embodiments of the application can process the coded data according to the type of coding mode of the current audio frame, so as to avoid the problem of audio discontinuity and/or noise appearance, and thereby improve the audio signal quality.

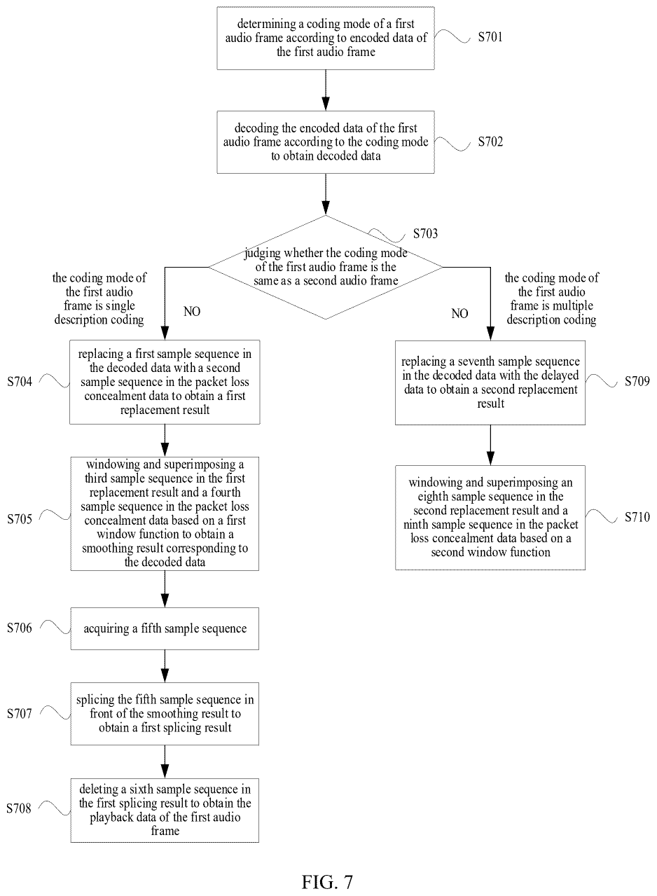

As refinement and extension of the above embodiments, an embodiment of the present disclosure provides an audio data decoding method. Referring to FIG. 7, the audio data decoding method includes the following steps:
S701: determining a coding mode of a first audio frame according to encoded data of the first audio frame.
S702: decoding the encoded data of the first audio frame according to the coding mode to obtain decoded data.
S703: judging whether the coding mode of the first audio frame is the same as a coding mode of a second audio frame.

Where, the second audio frame is a previous audio frame of the first audio frame.

In the above S703, if the coding mode of the first audio frame is the same as that of the second audio frame, and the coding mode of the first audio frame is single description coding, then the following S704 to S708 are executed:
S704: replacing a first sample sequence in the decoded data with a second sample sequence in the packet loss concealment data to obtain a first replacement result.

Where, the first sample sequence is a sample sequence composed of top first number of samples in the decoded data, and the first number is a difference between a first preset number and the delayed sample number; the second sample sequence is a sample sequence composed of samples in the packet loss concealment data whose index values range from the delayed sample number to the first preset number.

In some embodiments, if the coding mode of the current audio frame is multiple description coding, the original data of the current audio frame is written into a transition buffer (transition_buffer), while if the coding mode of the current audio frame is single description coding, the low-frequency data obtained by frequency division of the original data of the current audio frame is written into a designated buffer, so that when the second data needs to be obtained, the low-frequency data obtained by frequency division of the original audio data of the previous audio frame can be directly read from the delay_buffer. The decoded data will be stored in a pulse code modulation buffer (pcm_buffer), the first replacement result will be written in the storage location of the original decoded data in the pulse code modulation buffer, and the second replacement result obtained in S707 will also be written in the storage location of the original decoded data in the pulse code modulation buffer.

In the present embodiment, the decoded data is stored in the pulse code modulation buffer, and the first sample sequence in the decoded data is the top F5-Fd sample sequences in the pulse code modulation buffer. The second sample sequence in the packet loss concealment data is a sample sequence in the packet loss concealment data with index values ranging from Fd to F5, and obtaining the first replacement result can be implemented by the following formulas:

$$pcm\_buffe ( i - Fd ) = transition\_buffer ( i )$$

$$i = Fd , … … , F 5 - 1$$

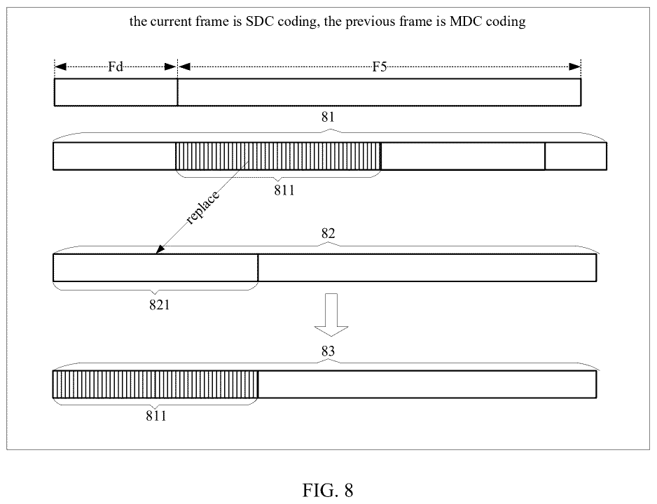

In the present embodiment, referring to FIG. 8, the delayed sample number is Fd, and the first preset number is F5. In FIG. 8, the packet loss concealment data (packet loss concealment data 81) generated based on the second audio frame is stored in the transition buffer, a sample sequence composed of samples in the transition buffer whose index values range from the delayed sample number to the first preset number is stored in the second sample sequence 811, the decoded data (decoded data 82) obtained by decoding the encoded data of the first audio frame according to the coding mode is stored in the pulse code modulation buffer, and the top first number of samples in the pulse code modulation buffer composes a sample sequence (first sample sequence 821). Then the above step S704 is to replace the first sample sequence 821 in the decoded data 82 with the second sample sequence 811 in the packet loss concealment data 81 to obtain the first replacement result 83.
S705: windowing and superimposing a third sample sequence in the first replacement result and a fourth sample sequence in the packet loss concealment data based on a first window function to obtain a smoothing result corresponding to the decoded data.

Where, the third sample sequence is a sample sequence composed of samples in the first replacement result whose index values range from the first number to a sum of the first number and a second preset number; the fourth sample sequence is a sample sequence composed of samples in the packet loss concealment data whose index values range from the first preset number to a sum of the first preset number and a second preset number.

Window function: Fourier transform can only transform time domain data of limited length, so it is necessary to perform signal truncation on the time domain signal. Even if it is a periodic signal, if the truncation time length is not an integer multiple of the period (period truncation), then the intercepted signal will leak. In order to minimize this leakage error, a weighting function, also called a window function, needs to be utilized. The main purpose of windowing is to make the time domain signal appear to better meet the periodicity requirements of Fourier processing and reduce leakage. In this embodiment, the smoothing is performed according to the switching type, and transition smoothing is performed in a manner of windowing smoothing.

In the present embodiment, the third sample sequence is a sample sequence in the pulse code modulation buffer with index values ranging from F5-Fd to F5-Fd+F2.5. The fourth sample sequence is a sample sequence in the transition buffer with index values ranging from F5-Fd to F5-Fd+F2.5, and the smoothing result can be obtained by the following formula:

$$pcm\_buffe ( i + F 5 - Fd ) = w ( i ) * pcm ( i + F 5 - Fd ) + ( 1 - w ( i ) ) * transition\_buffer ( i + F 5 )$$

$$i = 0 , 1 , … … , F 2 \text{.5} - 1$$

Where, w(i) is the expression of a window function, and the smoothing method is to perform windowing and superimposing on the corresponding part and the samples with indexes ranging from F5 to F5+F2.5 in the transition buffer to achieve the purpose of smooth transition.

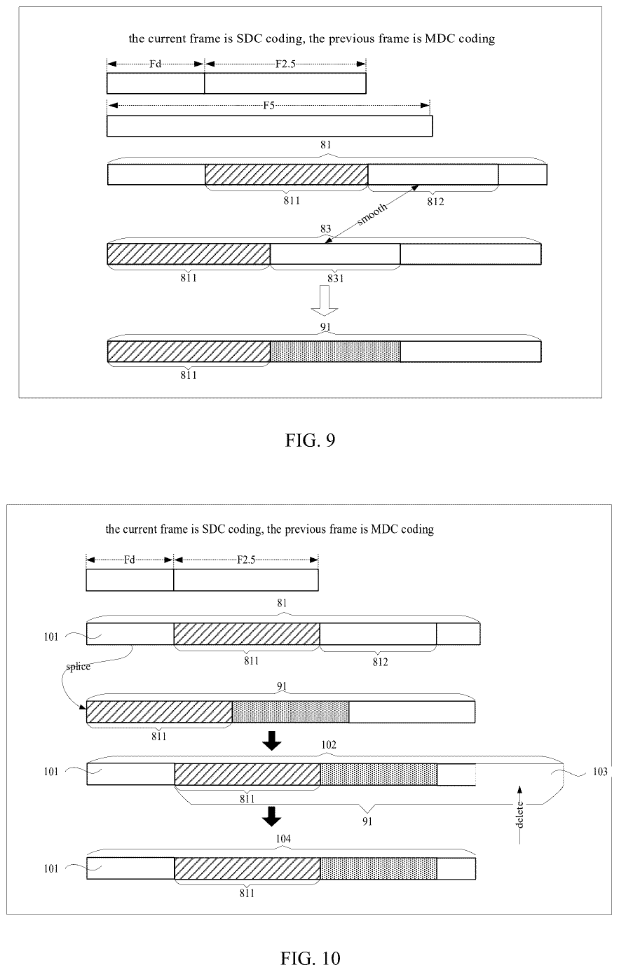

On the basis of the above embodiment shown in FIG. 8, referring to FIG. 9, the second preset number is F2.5. On the basis of S704, the sample sequence composed of samples in the transition buffer with index values ranging from the first preset number to the sum of the first preset number and the second preset number is the fourth sample sequence 812, and the sample sequence composed of samples in the first replacement result 83 in the pulse code modulation buffer with index values ranging from the first number to the sum of the first number and the second preset number is the third sample sequence 831. Windowing and superimposing the third sample sequence 831 in the first replacement result 83 and the fourth sample sequence 812 in the packet loss concealment data 81 can obtain a smoothing result 91 corresponding to the decoded data.
S706: acquiring a fifth sample sequence.

Where the fifth sample sequence is a sample sequence composed of top delayed sample number of samples in the packet loss concealment data.

In the present embodiment, the fifth sample sequence is a sequence of top Fd samples in the transition buffer. The acquiring the fifth sample sequence can be implemented by the following formula:

$$delay\_buffer ( i ) = transition\_buffer ( i )$$

$$i = 0 , 1 , … … Fd - 1$$

S707. splicing the fifth sample sequence in front of the smoothing result to obtain a first splicing result.
S708: deleting a sixth sample sequence in the first splicing result to obtain the playback data of the first audio frame.

Where, the sixth sample sequence is a sample sequence composed of bottom delayed sample number of samples in the first splicing result.

On the basis of the above embodiment shown in FIG. 9, referring to FIG. 10, a sample sequence composed of the top delayed sample number of samples in the packet loss concealment data is a fifth sample sequence 101. First, the fifth sample sequence 101 is spliced in front of the smoothing result 91 to obtain a first stitching result 102, and the sample sequence composed of the bottom delayed sample number of samples in the first stitching result 102 is the sixth sample sequence 103, then, the sixth sample sequence 103 in the first stitching result 102 is deleted to obtain the playback data 104 of the first audio frame, the playback data 104 of the first audio frame is composed of the fifth sample sequence 101, the second sample sequence 811, and the remaining part of the first stitching result 102 after deletion of the sixth sample sequence at its tail end.

In the above S703, if the coding mode of the first audio frame is the same as that of the second audio frame, and the coding mode of the first audio frame is multiple description coding, then the following S709 and S710 are executed:
S709. replacing a seventh sample sequence in the decoded data with the delayed data to obtain a second replacement result; the seventh sample sequence is a sample sequence composed of top delayed sample number of samples in the decoded data, and the obtaining the second replacement result can be implemented by the following formula:

$$pcm\_buffer ( i ) = delay\_buffer ( i )$$

$$i = 0 , 1 , … … qmf\_order - 2$$

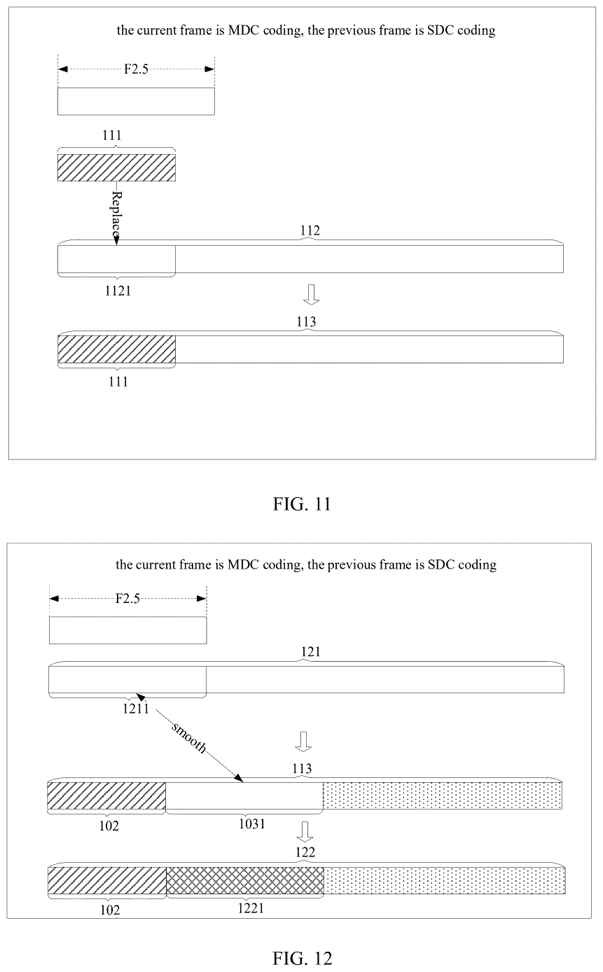

In the present embodiment, as shown in FIG. 11, the decoded data (decoded data 112) obtained by decoding the encoded data of the first audio frame according to the coding mode is located in the pulse code modulation buffer, a sample sequence composed of the top qumf_order-1 samples in the pulse code modulation buffer is the seventh sample sequence 1121, and a sample sequence composed of the top qumf_order-1 samples in the delay buffer is the delay data 111, and the seventh sample sequence 1121 in the decoded data 112 is replaced by the delay data 111 to obtain a second replacement result 113, the second replacement result 113 is composed of the delay data 111 and the remaining part at the tail end of the decoded data 112.
S710: windowing and superimposing an eighth sample sequence in the second replacement result and a ninth sample sequence in the packet loss concealment data based on a second window function.

Where, the eighth sample sequence is a sample sequence composed of samples in the second replacement result whose index values range from the delayed sample number to a sum of the delayed sample number and a third preset number; the ninth sample sequence is a sample sequence composed of top third preset number of samples in the packet loss concealment data, the above step of windowing and superimposing the eighth sample sequence in the second replacement result and the ninth sample sequence in the packet loss concealment data based on the second window function can be implemented by the following formula:

$$pcm\_buffe ( i + qmf\_order - 1 ) = ( i ) * pcm ( i + qmf\_order - 1 ) + ( 1 - ( i ) ) * transition\_buffer ( i ) ,$$

$$i = 0 , 1 , … … F 2 \text{.5} - 1$$

In the present embodiment, on the basis of the embodiment shown in FIG. 11, referring to FIG. 12, the sample sequence composed of the top third preset number of samples in the transition buffer is the ninth sample sequence 1211, and the sample sequence composed of samples in the second replacement result 113 in the pulse code modulation buffer with index values ranging from the delayed sample number to the sum of the delayed sample number and the third preset number is the eighth sample sequence 1031. windowing and superimposing the eighth sample sequence 1031 and the ninth sample sequence 1211 in the packet loss concealment data 121 can result in a result 122, which is composed of the delay data 102, a smooth result 1221 obtained by windowing and superimposing the ninth sample sequence 1211 and the eighth sample sequence 1031, and the remaining part at the end of the second replacement result 104.

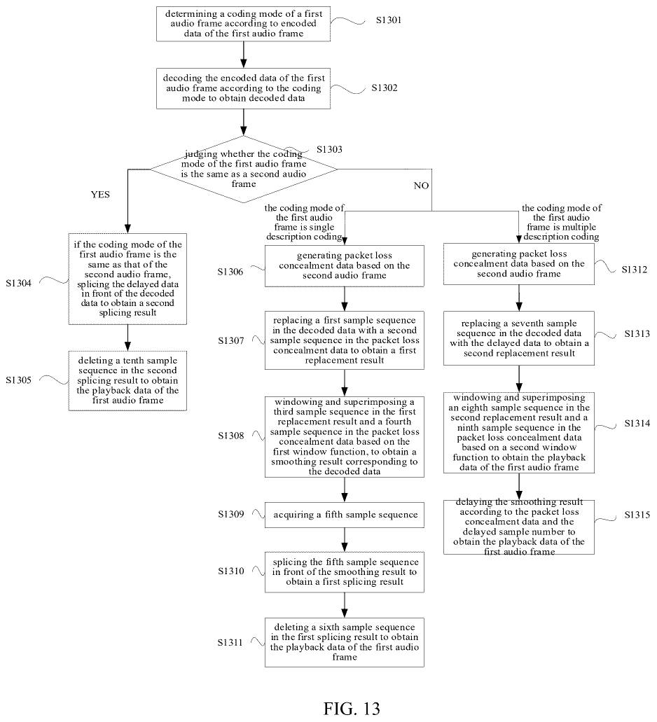

As refinement and extension of the above embodiments, an embodiment of the present disclosure provides a method of processing audio data. Referring to FIG. 13, the method of processing audio data includes the following steps:
S1301: determining a coding mode of a first audio frame according to encoded data of the first audio frame.
S1302: decoding the encoded data of the first audio frame according to the coding mode to obtain decoded data.
S1303: judging whether the coding mode of the first audio frame is the same as a coding mode of a second audio frame.

In the above S1303, if the coding mode of the first audio frame is the same as that of the second audio frame, then the following steps S1304 and S305 are executed:
S1304. splicing the delayed data in front of the decoded data to obtain a second splicing result.
S1305. deleting a tenth sample sequence in the second splicing result to obtain the playback data of the first audio frame.

Where, the tenth sample sequence is a sample sequence composed of bottom delayed sample number of samples in the second splicing result.

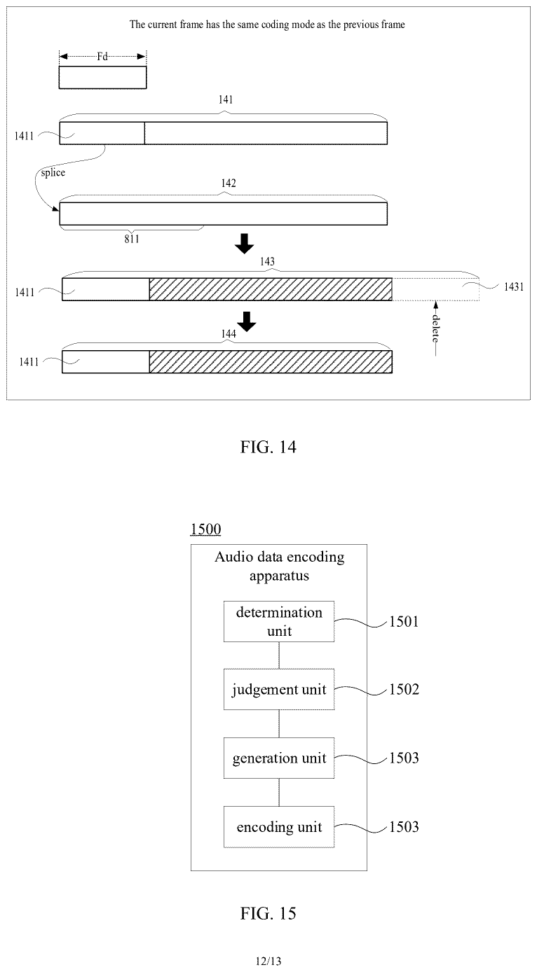

In some embodiments, the above steps a and b can refer to FIG. 14, the delay data 1411 is a sequence of top qmf_order-1 samples in the delay buffer, and the delay data 1411 is spliced in front of the decoded data 142 to obtain a second splicing result 143. A sample sequence composed of the bottom delayed sample number of samples in the second stitching result 143 is the tenth sample sequence 1431, and then the tenth sample sequence 1431 in the second splicing result 143 is deleted so as to obtain the playback data 144 of the first audio frame, which is composed of the delayed data 1411 and the remaining part at the tail end of the decoded data 142.

In the above S1303, if the coding mode of the first audio frame is different from that of the second audio frame, and the coding mode of the first audio frame is single description coding, then the following S1306 to S1311 are executed:
S1306: generating packet loss concealment data based on the second audio frame.
S1307: replacing a first sample sequence in the decoded data with a second sample sequence in the packet loss concealment data to obtain a first replacement result.

Where, the first sample sequence is a sample sequence composed of top first number of samples in the decoded data, and the first number is the difference between a first preset number and the delayed sample number; the second sample sequence is a sample sequence composed of samples in the packet loss concealment data whose index values range from the delayed sample number to the first preset number.
S1308. windowing and superimposing a third sample sequence in the first replacement result and a fourth sample sequence in the packet loss concealment data based on the first window function, to obtain a smoothing result corresponding to the decoded data.

Where, the third sample sequence is a sample sequence composed of samples in the first replacement result whose index values range from the first number to a sum of the first number and a second preset number; the fourth sample sequence is a sample sequence composed of samples in the packet loss concealment data whose index values range from the first preset number to a sum of the first preset number and the second preset number.
S1309: acquiring a fifth sample sequence.

Where, the fifth sample sequence is a sample sequence composed of top delayed sample number of samples in the packet loss concealment data.
S1310: splicing the fifth sample sequence in front of the smoothing result to obtain a first splicing result.
S1311: deleting a sixth sample sequence in the first splicing result to obtain the playback data of the first audio frame.

Where, the sixth sample sequence is a sample sequence composed of bottom delayed sample number of samples in the first splicing result.

In the above S1303, if the coding mode of the first audio frame is different from that of the second audio frame, and the coding mode of the first audio frame is multiple description coding, then the following S1312 to S1315 are executed:
S1312. generating packet loss concealment data based on the second audio frame.
S1313: replacing a seventh sample sequence in the decoded data with the delayed data to obtain a second replacement result.
S1314: windowing and superimposing an eighth sample sequence in the second replacement result and a ninth sample sequence in the packet loss concealment data based on a second window function to obtain the playback data of the first audio frame.

Where, the eighth sample sequence is a sample sequence composed of samples in the second replacement result whose index values range from the delayed sample number to a sum of the delayed sample number and a third preset number; the ninth sample sequence is a sample sequence composed of top third preset number of samples in the packet loss concealment data.
S1315: delaying the smoothing result according to the packet loss concealment data and the delayed sample number to obtain the playback data of the first audio frame.

Based on the same inventive concept, as an implementation of the above methods, embodiments of the present disclosure also provide an encoding apparatus and a decoding apparatus for audio data, which correspond to the above method embodiments. For convenience of reading, the embodiments will not repeat the details of the above method embodiments one by one, but it should be clear that the audio data processing apparatuses in the embodiments can implement all the contents of the above method embodiments correspondingly.

An embodiment of the present disclosure provides an audio data encoding apparatus, and FIG. 15 is a structural schematic diagram of a processing apparatus for the audio data. Referring to FIG. 15, the audio data processing apparatus 1500 includes:
a determination unit 1501, configured to determine a coding mode of a first audio frame;
a judgement unit 1502, configured to judge whether the coding mode of the first audio frame is the same as a coding mode of a second audio frame; wherein the second audio frame is a previous audio frame of the first audio frame;
a generation unit 1503, configured to, in response to that the coding mode of the first audio frame is different from a coding mode of a second audio frame and the coding mode of the first audio frame is multiple description coding, generate target data based on first data, second data and a first delay; the first data is low-frequency data obtained by frequency division of original audio data of the first audio frame, the second data is low-frequency data obtained by frequency division of original audio data of the second audio frame, and the first delay is a coding delay of the multiple description coding;
the generation unit 1503 is further configured to, in response to that the coding mode of the first audio frame is different from that of the second audio frame and the coding mode of the first audio frame is single description coding, generate sixth data as the target data based on fourth data, fifth data and a second delay; the fourth data is the original audio data of the first audio frame, the fifth data is the original audio data of the second audio frame, and the second delay is a coding delay of the single description coding;
an encoding unit 1504, configured to encode the target data according to the coding mode of the first audio frame, to obtain encoded data of the first audio frame.

As an optional implementation of the embodiment of the present disclosure, the generation unit 1503 is specifically configured to: intercept samples with length of the first delay from the tail end of the second data to obtain seventh data; splice the seventh data at the head end of the first data to obtain eighth data; delete samples with the length of the first delay from the tail end of the eighth data to obtain the target data.

As an optional implementation of the embodiment of the present disclosure, the generation unit 1503 is specifically configured to: intercept samples with length of the second delay from the tail end of the fifth data to obtain ninth data; splice the ninth data at the head end of the fourth data to obtain tenth data; delete samples with the length of the second delay from the tail end of the tenth data to obtain the target data.

As an optional implementation of the embodiment of the present disclosure, the determination unit 1501 is specifically configured to: determine whether a coding mode switching condition is met based on a signal type of the first audio frame and a coding mode duration; wherein the coding mode duration is a playback duration of an audio frame continuously encoded in a current coding mode; if not, determine the coding mode of the second audio frame as the coding mode of the first audio frame; if so, determine the coding mode of the first audio frame according to network parameters of an encoded audio data transmission network.

As an optional implementation of the embodiment of the present disclosure, the determination unit 1501 is specifically configured to: judge whether the coding mode duration is greater than a threshold duration; judge whether a probability that the first audio frame is a voice audio frame is less than a threshold probability; in response to that the coding mode duration is greater than the threshold duration and the probability that the first audio frame is a voice audio frame is less than the threshold probability, determine that the coding mode switching condition is met; in response to that the coding mode duration is less than or equal to the threshold duration and/or the probability that the first audio frame is a voice audio frame is greater than or equal to the threshold probability, determine that the coding mode switching condition is not met.

As an optional implementation of the embodiment of the present disclosure, the determination unit 1501 is specifically configured to: determine a packet loss rate of the encoded audio data transmission network according to the network parameters; judge whether the packet loss rate is greater than or equal to a threshold packet loss rate; if so, determine that the coding mode of the first audio frame is the multiple description coding; if not, determine that the coding mode of the first audio frame is the single description coding.

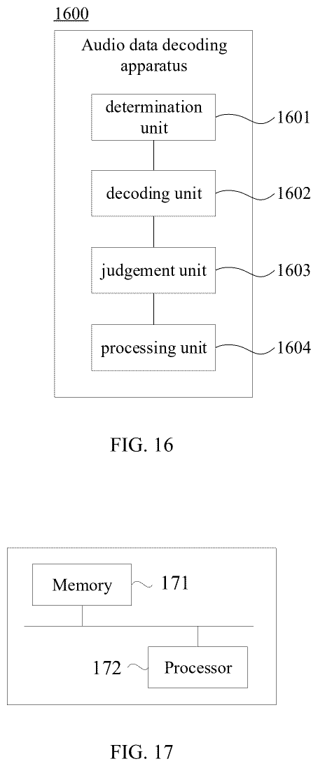

An embodiment of the present disclosure provides an audio data decoding apparatus, and FIG. 16 is a structural schematic diagram of the audio data decoding apparatus. Referring to FIG. 16, the audio data decoding apparatus 1600 includes:
a determination unit 1601, configured to determine a coding mode of a first audio frame according to encoded data of the first audio frame;
a decoding unit 1602, configured to decode the encoded data of the first audio frame according to the coding mode to obtain decoded data;
a judgement unit 1603, configured to judge whether the coding mode of the first audio frame is the same as a coding mode of a second audio frame; the second audio frame is a previous audio frame of the first audio frame;
a processing unit 1604, configured to, in response to that the coding mode of the first audio frame is different from the coding mode of the second audio frame, and the coding mode of the first audio frame is single description coding, generate packet loss concealment data based on the second audio frame; smooth the decoded data according to the packet loss concealment data, to obtain a smoothing result corresponding to the decoded data; delay the smoothing result according to the packet loss concealment data and a delayed sample number to obtain playback data of the first audio frame; the delayed sample number is the delayed sample number in the multiple description coding;
the processing unit 1604 is further configured to, in response to that the coding mode of the first audio frame is different from a coding mode of a second audio frame and the coding mode of the first audio frame is multiple description coding, generate packet loss concealment data based on the second audio frame; and smooth the decoded data according to delay data of the second audio frame and the packet loss concealment data, to obtain playback data of the first audio frame.

As an optional implementation of the embodiment of the present disclosure, the processing unit 1604 is specifically configured to: replace a first sample sequence in the decoded data with a second sample sequence in the packet loss concealment data to obtain a first replacement result; the first sample sequence is a sample sequence composed of top first number of samples in the decoded data, and the first number is a difference between a first preset number and the delayed sample number; the second sample sequence is a sample sequence composed of samples in the packet loss concealment data whose index values range from the delayed sample number to the first preset number; window and superimpose a third sample sequence in the first replacement result and a fourth sample sequence in the packet loss concealment data based on a first window function to obtain a smoothing result corresponding to the decoded data, wherein the third sample sequence is a sample sequence composed of samples in the first replacement result whose index values range from the first number to a sum of the first number and a second preset number; the fourth sample sequence is a sample sequence composed of samples in the packet loss concealment data whose index values range from the first preset number to a sum of the first preset number and a second preset number.

As an optional implementation of the embodiment of the present disclosure, the processing unit 1604 is specifically configured to: acquire a fifth sample sequence, wherein the fifth sample sequence is a sample sequence composed of top delayed sample number of samples in the packet loss concealment data; splice the fifth sample sequence in front of the smoothing result to obtain a first splicing result; delete a sixth sample sequence in the first splicing result to obtain the playback data of the first audio frame, wherein the sixth sample sequence is a sample sequence composed of bottom delayed sample number of samples in the first splicing result.

As an optional implementation of the embodiment of the present disclosure, the processing unit 1604 is specifically configured to: replace a seventh sample sequence in the decoded data with the delayed data to obtain a second replacement result; the seventh sample sequence is a sample sequence composed of top delayed sample number of samples in the decoded data; window and superimpose an eighth sample sequence in the second replacement result and a ninth sample sequence in the packet loss concealment data based on a second window function to obtain the playback data of the first audio frame, wherein the eighth sample sequence is a sample sequence composed of samples in the second replacement result whose index values range from the delayed sample number to a sum of the delayed sample number and a third preset number; the ninth sample sequence is a sample sequence composed of top third preset number of samples in the packet loss concealment data.

As an optional implementation of the embodiment of the present disclosure, the processing unit 1604 is configured to: in response to that the coding mode of the first audio frame is the same as the coding mode of the second audio frame, and the coding mode of the first audio frame is single description coding, delay the decoded data according to delayed data of the second audio frame and the delayed sample number to obtain the playback data of the first audio frame.

As an optional implementation of the embodiment of the present disclosure, the processing unit 1604 is specifically configured to: splice the delayed data in front of the decoded data to obtain a second splicing result; delete a tenth sample sequence in the second splicing result to obtain the playback data of the first audio frame, wherein the tenth sample sequence is a sample sequence composed of bottom delayed sample number of samples in the second splicing result.

The audio data processing apparatus provided by the embodiments can execute the audio data processing method provided by the above method embodiments, and have similar implementation principle and the technical effect, so that the details are not repeated here.

Based on the same inventive concept, an embodiment of the present disclosure also provides an electronic device. FIG. 17 is a schematic structural diagram of an electronic device provided by an embodiment of the present disclosure. As shown in FIG. 17, the electronic device provided by the embodiment includes a memory 1701 and a processor 1702, wherein the memory 1701 is used for storing a computer program; the processor 1702 is used to execute the audio data processing method provided in the above embodiments when executing the computer program.

Based on the same inventive concept, an embodiment of the present disclosure also provides a computer-readable storage medium, on which a computer program is stored, which, when executed by a processor, causes a computing device to implement the audio data processing method provided by the above embodiments.

Based on the same inventive concept, an embodiment of the present disclosure also provides a computer program product, which, when running on a computer, enables the computing device to realize the audio data processing method provided in the above embodiments.

It should be understood by those skilled in the art that embodiments of the present disclosure can be provided as a method, a system, or a computer program product. Therefore, the present disclosure can take the form of an entirely hardware embodiment, an entirely software embodiment, or an embodiment combining software and hardware aspects. Moreover, the present disclosure may take the form of a computer program product embodied on one or more computer usable storage media having computer usable program codes embodied therein.

The processor may be a central processing unit (CPU), other general processors, Digital Signal Processor (DSP), application specific integrated circuits (ASIC), Field-Programmable Gate Array (FPGA) or other programmable logic devices, discrete gate or transistor logic devices, discrete hardware components, etc. The general processor can be a microprocessor, or the processor can be any conventional processor, etc.

Memory may include non-permanent memory, random access memory (RAM) and/or nonvolatile memory in computer-readable media, such as read-only memory (ROM) or flash memory (flash RAM). Memory is an example of a computer-readable medium.

Computer readable media include permanent and non-permanent, removable and non-removable storage media. The storage medium can store information by any method or technology, and the information can be computer-readable instructions, data structures, program modules or other data. Examples of storage media for computers include, but not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, digital versatile disc (DVD) or other optical storage, and magnetic cassette tape, magnetic disk storage, or other magnetic storage, or any other non-transmission medium, which can be used for storing information accessible by the computing device. According to the definition in the context, the computer-readable media may not include transitory computer-readable media, such as modulated data signals and carrier waves.

Finally, it should be explained that the above embodiments are only used to illustrate the technical scheme of the present disclosure, but not to limit it; although the present disclosure has been described in detail with reference to the foregoing embodiments, it should be understood by those skilled in the art that the technical scheme described in the foregoing embodiments can still be modified, or some or all of its technical features can be replaced by equivalents; however, these modifications or substitutions do not make the essence of the corresponding technical solutions deviate from the scope of the technical solutions of various embodiments of this disclosure.

1. An audio data encoding method, comprising:
determining a coding mode of a first audio frame;
judging whether the coding mode of the first audio frame is a same coding mode as a coding mode of a second audio frame; wherein the second audio frame is a previous audio frame of the first audio frame;
in response to the coding mode of the first audio frame being different from the coding mode of the second audio frame and the coding mode of the first audio frame is multiple description coding, generating third data based on first data, second data and a first delay; the first data is low-frequency data obtained by frequency division of original audio data of the first audio frame, the second data is low-frequency data obtained by frequency division of original audio data of the second audio frame, and the first delay is a coding delay of the multiple description coding; and
performing the multiple description coding on the third data to obtain encoded data of the first audio frame.

2. The method of claim 1, wherein the method further comprises:
in response to that the coding mode of the first audio frame is different from that of the second audio frame and the coding mode of the first audio frame is single description coding, generating sixth data based on fourth data, fifth data and a second delay; the fourth data is the original audio data of the first audio frame, the fifth data is the original audio data of the second audio frame, and the second delay is a coding delay of the single description coding; and
performing the single description coding on the sixth data to obtain encoded data of the first audio frame.

3. The method of claim 1, wherein the generating the third data based on the first data, the second data and the first delay, comprises:
intercepting samples with length of the first delay from a tail end of the second data to obtain seventh data;
splicing the seventh data at a head end of the first data to obtain eighth data; and
deleting samples with the length of the first delay from the tail end of the eighth data to obtain the third data.

4. The method of claim 2, wherein the generating the sixth data based on the fourth data, the fifth data and the second delay, comprises:
intercepting samples with length of the second delay from a tail end of the fifth data to obtain ninth data;
splicing the ninth data at a head end of the fourth data to obtain tenth data; and
deleting samples with the length of the second delay from the tail end of the tenth data to obtain the sixth data.

5. The method of claim 1, wherein the determining the coding mode of the first audio frame comprises:
determining whether a coding mode switching condition is met based on a signal type of the first audio frame and a coding mode duration; wherein the coding mode duration is a playback duration of an audio frame continuously encoded in a current coding mode;
in response to the coding mode switching condition being not met, determining the coding mode of the second audio frame as the coding mode of the first audio frame; and
in response to the coding mode switching condition being met, determining the coding mode of the first audio frame according to network parameters of an encoded audio data transmission network.

6. The method of claim 5, wherein the determining whether the coding mode switching condition is met based on the signal type of the first audio frame and the coding mode duration, comprises:
judging whether the coding mode duration is greater than a threshold duration;
judging whether a probability that the first audio frame is a voice audio frame is less than a threshold probability;
in response to the coding mode duration being greater than the threshold duration and the probability that the first audio frame is the voice audio frame being less than the threshold probability, determining that the coding mode switching condition is met; and
in response to the coding mode duration being less than or equal to the threshold duration and/or the probability that the first audio frame is the voice audio frame being greater than or equal to the threshold probability, determining that the coding mode switching condition is not met.

7. The method of claim 5, wherein the determining the coding mode of the first audio frame according to the network parameters of the encoded audio data transmission network, comprises:
determining a packet loss rate of the encoded audio data transmission network according to the network parameters;
judging whether the packet loss rate is greater than or equal to a threshold packet loss rate;
in response to the packet loss rate being greater than or equal to the threshold packet loss rate, determining that the coding mode of the first audio frame is the multiple description coding; and
in response to the packet loss rate is less than the threshold packet loss rate, determining that the coding mode of the first audio frame is single description coding.

8.-16. (canceled)

17. An electronic device comprising: a memory and a processor, wherein the memory is used for storing a computer program; the processor is used to, when executing the computer program, cause the electronic device to implement:
determining a coding mode of a first audio frame;
judging whether the coding mode of the first audio frame is a same coding mode as a coding mode of a second audio frame; wherein the second audio frame is a previous audio frame of the first audio frame;
in response to that the coding mode of the first audio frame is different from a coding mode of a second audio frame and the coding mode of the first audio frame is multiple description coding, generating third data based on first data, second data and a first delay; the first data is low-frequency data obtained by frequency division of original audio data of the first audio frame, the second data is low-frequency data obtained by frequency division of original audio data of the second audio frame, and the first delay is a coding delay of the multiple description coding; and
performing the multiple description coding on the third data to obtain encoded data of the first audio frame.

18. A non-transitory computer-readable storage medium having a computer program stored thereon, the computer program, when executed by a computing device, causes the computing device to implement:
determining a coding mode of a first audio frame;
judging whether the coding mode of the first audio frame is a same coding mode as a coding mode of a second audio frame; wherein the second audio frame is a previous audio frame of the first audio frame;
in response to that the coding mode of the first audio frame is different from a coding mode of a second audio frame and the coding mode of the first audio frame is multiple description coding, generating third data based on first data, second data and a first delay; the first data is low-frequency data obtained by frequency division of original audio data of the first audio frame, the second data is low-frequency data obtained by frequency division of original audio data of the second audio frame, and the first delay is a coding delay of the multiple description coding; and
performing the multiple description coding on the third data to obtain encoded data of the first audio frame.

19. (canceled)

20. The electronic device of claim 17, wherein the processor is used to, when executing the computer program, cause the electronic device to further implement:
in response to that the coding mode of the first audio frame is different from that of the second audio frame and the coding mode of the first audio frame is single description coding, generating sixth data based on fourth data, fifth data and a second delay; the fourth data is the original audio data of the first audio frame, the fifth data is the original audio data of the second audio frame, and the second delay is a coding delay of the single description coding; and
performing the single description coding on the sixth data to obtain encoded data of the first audio frame.

21. The electronic device of claim 17, wherein the generating the third data based on the first data, the second data and the first delay, comprises:
intercepting samples with length of the first delay from a tail end of the second data to obtain seventh data;
splicing the seventh data at a head end of the first data to obtain eighth data; and
deleting samples with the length of the first delay from the tail end of the eighth data to obtain the third data.

22. The electronic device of claim 20, wherein the generating the sixth data based on the fourth data, the fifth data and the second delay, comprises:
intercepting samples with length of the second delay from a tail end of the fifth data to obtain ninth data;
splicing the ninth data at a head end of the fourth data to obtain tenth data; and
deleting samples with the length of the second delay from the tail end of the tenth data to obtain the sixth data.

23. The electronic device of claim 17, wherein the determining the coding mode of the first audio frame comprises:
determining whether a coding mode switching condition is met based on a signal type of the first audio frame and a coding mode duration; wherein the coding mode duration is a playback duration of an audio frame continuously encoded in a current coding mode;
in response to that the coding mode switching condition is not met, determining the coding mode of the second audio frame as the coding mode of the first audio frame; and
in response to that the coding mode switching condition is met, determining the coding mode of the first audio frame according to network parameters of an encoded audio data transmission network.

24. The electronic device of claim 23, wherein the determining whether the coding mode switching condition is met based on the signal type of the first audio frame and the coding mode duration, comprises:
judging whether the coding mode duration is greater than a threshold duration;
judging whether a probability that the first audio frame is a voice audio frame is less than a threshold probability;
in response to the coding mode duration being greater than the threshold duration and the probability that the first audio frame is the voice audio frame being less than the threshold probability, determining that the coding mode switching condition is met; and
in response to the coding mode duration being less than or equal to the threshold duration and/or the probability that the first audio frame is the voice audio frame being greater than or equal to the threshold probability, determining that the coding mode switching condition is not met.

25. The electronic device of claim 23, wherein the determining the coding mode of the first audio frame according to the network parameters of the encoded audio data transmission network, comprises:
determining a packet loss rate of the encoded audio data transmission network according to the network parameters;
judging whether the packet loss rate is greater than or equal to a threshold packet loss rate;
in response to that the packet loss rate is greater than or equal to the threshold packet loss rate, determining that the coding mode of the first audio frame is the multiple description coding; and
in response to that the packet loss rate is less than the threshold packet loss rate, determining that the coding mode of the first audio frame is single description coding.

26. The non-transitory computer-readable storage medium of claim 18, wherein the processor, when executing the computer program, causes the electronic device to further implement:
in response to the coding mode of the first audio frame being different from that of the second audio frame and the coding mode of the first audio frame being single description coding, generating sixth data based on fourth data, fifth data and a second delay; the fourth data is the original audio data of the first audio frame, the fifth data is the original audio data of the second audio frame, and the second delay is a coding delay of the single description coding; and
performing the single description coding on the sixth data to obtain encoded data of the first audio frame.

27. The non-transitory computer-readable storage medium of claim 18, wherein the generating the third data based on the first data, the second data and the first delay, comprises:
intercepting samples with length of the first delay from a tail end of the second data to obtain seventh data;
splicing the seventh data at a head end of the first data to obtain eighth data; and
deleting samples with the length of the first delay from the tail end of the eighth data to obtain the third data.

28. The non-transitory computer-readable storage medium of claim 26, wherein the generating the sixth data based on the fourth data, the fifth data and the second delay, comprises:
intercepting samples with length of the second delay from a tail end of the fifth data to obtain ninth data;
splicing the ninth data at a head end of the fourth data to obtain tenth data; and
deleting samples with the length of the second delay from the tail end of the tenth data to obtain the sixth data.

29. The non-transitory computer-readable storage medium of claim 18, wherein the determining the coding mode of the first audio frame comprises:
determining whether a coding mode switching condition is met based on a signal type of the first audio frame and a coding mode duration; wherein the coding mode duration is a playback duration of an audio frame continuously encoded in a current coding mode;
in response to that the coding mode switching condition is not met, determining the coding mode of the second audio frame as the coding mode of the first audio frame; and
in response to that the coding mode switching condition is met, determining the coding mode of the first audio frame according to network parameters of an encoded audio data transmission network.

30. The non-transitory computer-readable storage medium of claim 29, wherein the determining whether the coding mode switching condition is met based on the signal type of the first audio frame and the coding mode duration, comprises:
judging whether the coding mode duration is greater than a threshold duration;
judging whether a probability that the first audio frame is a voice audio frame is less than a threshold probability;
in response to that the coding mode duration is greater than the threshold duration and the probability that the first audio frame is a voice audio frame is less than the threshold probability, determining that the coding mode switching condition is met; and
in response to that the coding mode duration is less than or equal to the threshold duration and/or the probability that the first audio frame is a voice audio frame is greater than or equal to the threshold probability, determining that the coding mode switching condition is not met.
